(19) United States
(12) Patent Application Publication
(10) Pub. No.: US 2009/0217816 A1
(43) Pub. Date: Sep. 3, 2009

(54) BOLT SECURING ASSEMBLY AND METHOD FOR REPAIRING A WORN BOLT SECURING ASSEMBLY

(75) Inventor: Reinhard ROOS, Niedernhausen (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/389,214

(22) Filed: Feb. 19, 2009

(30) Foreign Application Priority Data
Feb. 20, 2008 (EP) 08003095.0-1252

(51) Int. Cl. F16J 1/18; B23P 6/02

(52) U.S. Cl. 92/256; 29/402.08

(57) ABSTRACT

A bolt securing assembly is provided for securing a piston bolt in a piston. The bolt securing assembly includes, but is not limited to a bolt received by an opening. The opening may be provided by a piston for an automobile combustion engine. The bolt is secured by a securing member in axial direction. The securing member comprises a spring force in axial direction. Since an unnecessary movement is prevented, but a necessary movement is allowed, the wear of the bolt securing assembly is reduced.

### CROSS-REFERENCE TO RELATED APPLICATION

This application claims priority to European Patent Application No. 08003095.0-1252, filed Feb. 20, 2008, which is incorporated herein by reference in its entirety.

### TECHNICAL FIELD

The invention relates to a bolt securing assembly, by which a bolt is secured in axial direction in an opening. Particularly the invention relates to a piston bolt securing assembly of an automobile combustion engine, by which a piston bolt is secured in axial direction in an opening of a piston, so that a conrod may be connected to the piston via the piston bolt. The invention further relates to a method for repairing a worn bolt securing assembly in order to receive a bolt securing assembly according to the invention.

### BACKGROUND

From DE 10 2006 013 904 A1, a piston bolt securing assembly of an automobile combustion engine is known, which comprises a piston with an opening, by which a piston bolt is secured. The opening of the piston comprises two grooves, and each groove receives a securing ring. The securing rings abut in axial direction to the piston bolt securing the piston bolt in axial direction. A conrod is connected to the piston via the piston bolt. It is a disadvantage of such kind of a bolt securing assembly, that the grooves and the securing rings are subjected to a high wear during operation.

It is at least one object of the invention to provide a bolt securing assembly which comprises less wear during operation and to provide a method for repairing a worn bolt securing assembly for receiving a bolt securing assembly according to the invention. In addition, other objects, desirable features, and characteristics will become apparent from the subsequent summary and detailed description, and the appended claims, taken in conjunction with the accompanying drawings and this background.

The bolt securing assembly according to an embodiment of the invention for securing a piston bolt in a piston comprises a bolt received by an opening. The opening may be provided by a piston for an automobile combustion engine. The bolt is secured by at least one securing member in axial direction. According to an embodiment of the invention the securing member comprises a spring force in axial direction.

Due to the spring force in the axial direction, a clearance in axial direction can be compensated. At the same time an axial movement of the bolt in axial direction is still possible so that a thermal expansion of the bolt does not lead to a jamming and/or a sudden force in axial direction may be damped. Since an unnecessary movement is prevented, but a necessary movement is allowed, the wear of the bolt securing assembly is reduced. Further an additional axial clearance of the bolt due to wear occurring during operation can be automatically compensated by the spring force of the securing member. The spring force is particularly provided from the beginning on, so that it is not necessary to heat the securing member in order to provide the necessary elasticity. Particularly the securing member comprises a significant spring deflection for compensating the clearance fit in axial direction of the bolt inside the opening. Due to the compensation of the axial movement of the bolt a significant reduction of the knocking noise of a combustion engine comprising such kind of a bolt securing assembly is possible. Measurements show that the maximum volume of the knocking noise can be reduced by nearly 50%.

In a preferred embodiment, the securing member comprises an open securing ring. The securing ring comprises a first end and a second end, and the first end and the second end are arranged axially displaced to each other. Due to this displacement the spring force can be provided. Due to the inclined alignment of the securing ring the ends can be moved to each other in axial direction against the spring force. Such the securing member can be manufactured from a single piece of spring wire and/or by bending a common securing ring. This leads to a cost efficient securing member.

Preferably, the securing member is received by a groove arranged inside the opening and/or the securing member is received by a bolt groove of the bolt. Due to the groove or bolt groove the securing member can be positioned on a defined place with respect to the opening or the bolt. Particularly, when the securing member is an open securing ring the securing member can be easily positioned into the groove or the bolt groove by compressing or expanding the securing ring in radial direction.

Particularly, the material of the securing member comprises a width s in axial direction and the groove and/or the bolt groove comprises a width S in axial direction, and S is greater than s. For instance when the securing member is a securing ring, the securing member comprises a mainly circular cross section, and the cross section comprises the diameter s. Due to the spring force in axial direction, the securing member may be press fitted into the groove and/or the bolt groove, but a spring loaded axial clearance is still possible. The spring loaded axial clearance is defined by the difference S−s. The axial clearance S−s is particularly about 0.5 mm≦S−s≦2.5 mm, preferably about 0.8 mm≦S−s≦2.0 mm and most preferred about 1.0 mm≦S−s≦1.5 mm. The ratio r of S to s is particularly 1.0≦r≦2.0, preferably 1.2≦r≦1.8 and most preferred 1.4≦r≦1.6.

Further, it is possible that the securing member abuts at least partial at a front face of the bolt. Thus, the securing member provides a stop in axial direction for the bolt. It is not necessary to provide the bolt with a bolt groove, so that the design and the manufacturing of the bolt may be facilitated.

A piston bolt securing assembly for an automobile combustion engine is also provided in accordance with an embodiment of the invention, which comprises a piston and a piston bolt. The piston and the piston bolt are arranged to a bolt securing assembly as previously described. This means that the piston comprises the opening, which receives the piston bolt. The piston bolt is secured by at least one securing member in axial direction. According to an embodiment of the invention, the securing member comprises a spring force in axial direction. The piston bolt assembly may be further designed as previously described.

A combustion engine, which comprises a piston bolt securing assembly as previously described, is also provided in accordance with an embodiment of the invention. The combustion engine particularly comprises a conrod connected to the piston via the piston bolt.

A method for repairing a worn bolt securing assembly is also provided in accordance with an embodiment of the invention. According to this method a worn bolt securing assembly is provided, which comprises a bolt received by an opening, and the opening comprises a worn groove, by which a securing ring is received. The at least one securing ring is removed from the respective worn groove. A securing member is inserted into the worn groove, which comprises a spring force in axial direction. Due to this method a bolt securing assembly as previously described is provided.

Particularly, it is not necessary to change a worn piston or the like, but only to exchange the securing ring by a securing member, which comprises a spring force in axial direction. Thereby is used the insight that due to a thermal expansion of the bolt or due to a sudden force in axial direction to the bolt a wear would mainly lead to a broadened groove for the securing ring. The broadened width of groove can be automatically compensated by the spring deflection of the securing member, so that optimized operation conditions may be provided independently of the amount of the wear.

### BRIEF DESCRIPTION OF THE DRAWINGS

The embodiments of the invention will hereinafter be described in conjunction with the following drawing figures, wherein like numerals denote like elements, and:

FIG. 1 is a schematic cross section of a bolt securing assembly according to an embodiment of the invention; and

FIG. 2 is a schematic detailed view of FIG. 1.

### DETAILED DESCRIPTION

The following detailed description is merely exemplary in nature and is not intended to limit application and uses. Furthermore, there is no intention to be bound by any theory presented in the preceding background and summary or the following detailed description.

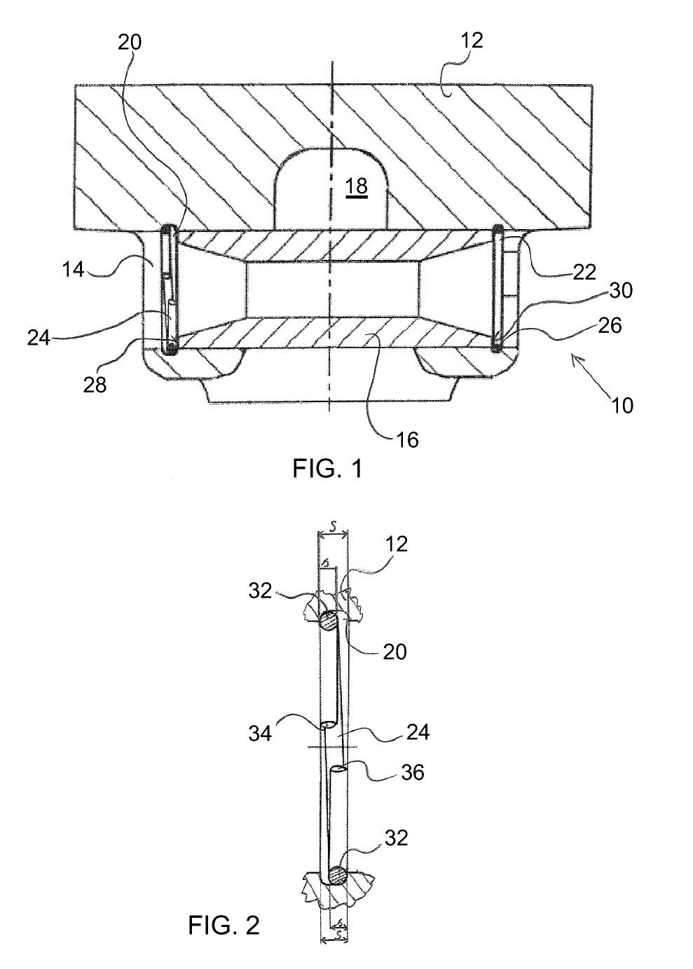

The bolt securing assembly 10 as illustrated in FIG. 1 comprises a piston 12, which comprises an opening 14 by which a piston bolt 16 is received. In the illustrated embodiment the piston bolt 16 is mainly designed as hollow cylinder, which may be received in the middle by a not illustrated conrod connected to a crank. The piston 12 comprises a receiving space 18 for receiving the conrod without interference to the piston 12.

The opening 14 of the piston 12 comprises a first groove 20 and a second groove 22. By the first groove 20 a securing member 24 is received, while by the second groove 22 a common securing ring 26 is received. The securing member 24 abuts partially to a first front face 28 of the bolt 16. Since the securing member comprises a spring force in axial direction an axial clearance of the bolt 16 can be automatically compensated. The securing ring 26 abuts to a second front face 30 of the bolt and provides a stop for the bolt 16 in axial direction.

As illustrated in FIG. 2, the securing member 24 is designed as an open securing ring, which comprises a circular cross section 32. The material of the securing member defined by the cross section 32 comprises in axial direction a width s, while the groove 20 comprises in axial direction a width S, which is significant greater than the width s of the securing member 24. Since the securing member 24 is designed as an open securing ring, the securing member comprises a first end 34 and a second end 36, which are displaced in axial direction to each other to provide the spring force.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A bolt securing assembly for securing a piston bolt in a piston, comprising:
a bolt received by an opening; and
a securing member for securing the bolt in an axial direction, wherein the securing member comprises a spring force in the axial direction.

2. The bolt securing assembly according to claim 1, wherein the securing member comprises an open securing ring and the open securing ring comprises a first end and a second end axially displaced to each other for providing the spring force.

3. The bolt securing assembly according to claim 1, wherein the securing member is received by a groove arranged inside the opening

4. The bolt securing assembly according to claim 1, wherein the securing member is received by a bolt groove of the bolt.

5. The bolt securing assembly according to claim 3, wherein a material of the securing member comprises an s-width in the axial direction and the groove comprises an S-width in the axial direction, wherein the S-width is greater than the s-width and an axial S−s clearance is particularly about 0.5 mm≦S−s≦2.5 mm.

6. The bolt securing assembly according to claim 4, wherein a material of the securing member comprises a width in the axial direction and the bolt groove comprises an S-width in the axial direction, wherein the S-width is greater than the s-width and an axial S−s clearance is particularly about 0.5 mm≦S−s≦2.5 mm.

7. The bolt securing assembly according to claim 1, wherein the securing member abuts at least partially at a front face of the bolt.

8. A piston bolt securing assembly for a combustion engine of an automobile, comprising:
a piston;
a piston bolt; and
a bolt securing assembly for securing the piston bolt in the piston, the bolt securing assembly, comprising:
a bolt received by an opening; and
a securing member for securing the bolt in an axial direction, wherein the securing member comprises a spring force in the axial direction.

9. The piston bolt securing assembly according to claim 8, further comprising a conrod connected to the piston via the piston bolt.

10. A method for repairing a worn bolt securing assembly, comprising the steps of:
providing the worn bolt securing assembly that comprises a bolt received by an opening that comprises a worn groove for securing a securing ring;
removing the securing ring; and
inserting a securing member that comprises a spring force in axial direction into the worn groove for providing a bolt securing assembly.
